(19) United States
(12) Patent Application Publication
(10) Pub. No.: US 2017/0008690 A1
(43) Pub. Date: Jan. 12, 2017

(54) PORTABLE MEDICINE FEEDER

(71) Applicant: Miin-Tsang Sheu, Changhua County (TW)

(72) Inventor: Miin-Tsang Sheu, Changhua County (TW)

(21) Appl. No.: 14/793,911

(22) Filed: Jul. 8, 2015

(51) Int. Cl. B65D 83/04; B65D 43/16; B65D 43/22; A61J 1/03; B65D 21/02

(52) U.S. Cl. CPC B65D 83/0481; A61J 1/03; B65D 21/0206; B65D 43/22; B65D 43/16; B65D 2583/0445

(57) ABSTRACT

A portable medicine feeder includes a storage box formed by a recessed body and an extension part extending outward from a front end of the recessed body. A bottom of the extension part extends outward and upward from a place adjacent to the recessed body to form a sloping slide outlet with a gradually-reduced rim. The medicine feeder further includes a lid whose cross-sectional shape is identical to that of a top end of the storage box. The lid is disposed over the storage box for covering the top end of the storage box. An annular peripheral wall is formed on a lower surface of the lid relative to an inner side edge of the top end of the storage box. The annular peripheral wall abuts against the inner side edge when the lid covers the storage box.

### BACKGROUND OF THE INVENTION

1. Field of the Invention

This invention relates to a device which is easy to feed medicine into the mouth of the taker with one hand and relates particularly to a portable medicine feeder.

2. Description of the Related Art

Different kinds of medicine boxes are made to receive and store medicine. A well-known medicine box usually has a plurality of bars crossing each other so that the box can be divided into rooms for separating medicine pieces and arranging them into classes according to dosages, dates or time points.

To take the medicine, the taker usually puts medicine pieces on the hand and feeds the pieces into the mouth. This feeding operation is not convenient and is easy to contaminate the medicine pieces.

### SUMMARY OF THE INVENTION

An object of this invention is to provide a waterproof portable medicine feeder which uses a connection between a lid and a storage box to provide an open-close operation and attain the effect of taking inside medicine pieces conveniently. The medicine feeder further designs a gradually-reduced rim at a front end of an extension part to form a sloping slide outlet whereby a front end of the slide outlet is placed into and across a labial margin of a taker to make the storage box slope by raising a rear of the storage box at the time of feeding.

Therefore, medicine pieces can directly slide into the mouth of the taker to complete the feeding operation. Further, a plurality of portable medicine feeders can be juxtaposed by one line facing a same direction, juxtaposed by two lines facing opposite directions or arranged into a radiating structure which spreads in different directions, thereby providing a variety of choices for consumers and increasing the willingness to consume.

The portable medicine feeder of this invention includes a storage box formed by a recessed body and an extension part extending outward from a front end of the recessed body. A bottom of the extension part extends outward and upward from a place close to the recessed body to form a sloping slide outlet with a gradually-reduced rim. The medicine feeder further includes a lid whose cross-sectional shape is identical to a cross-sectional shape of a top end of the storage box. The lid is disposed over the storage box for opening and closing the top end of the storage box. An annular peripheral wall is formed on a lower surface of the lid relative to an inner side edge of the top end of the storage box. The annular peripheral wall can abut against the inner side edge of the top end of the storage box when the storage box is covered by the lid.

Preferably, in one preferred embodiment, a pivot shaft extends outward from an upper outside surface of the recessed body far away from the extension part. A locking ring is disposed at one end of the lid. The locking ring and the pivot shaft of the storage box are pivotally connected to render the lid capable of opening and closing the storage box.

Preferably, a portion of the storage box far away from the extension part and a portion where the lid and the storage box are connected are integrally formed.

Preferably, in one preferred embodiment, a plurality of medicine feeders can be connected together . The medicine feeders are juxtaposed by connecting two side surfaces of the adjacent medicine feeders together and directed toward a same direction. With the aid of the gradually-reduced rim of the slide outlet, a space between outlets of any two adjacent medicine feeders can be enlarged to facilitate an easy operation of directly feeding medicine pieces within the medicine feeders into the mouth of the taker in sequence.

Preferably, in one preferred embodiment, a plurality of medicine feeders can be connected together. The medicine feeders are divided into a first group and a second group. The medicine feeders of the first group and the medicine feeders of the second group are respectively juxtaposed by connecting two side surfaces of the adjacent medicine feeders together, and the medicine feeders of each group face a same direction. One end of each medicine feeder of the first group where the storage box and the lid are connected is further connected to one end of each medicine feeder of the second group where the storage box and the lid are connected.

Preferably, in one preferred embodiment, a plate extends outward from a part of the lid in the proximity of the extension part.

Preferably, in one preferred embodiment, the lid is made of a soft material.

### BRIEF DESCRIPTION OF THE DRAWINGS

FIG. 1 is a perspective view showing a first preferred embodiment of this invention in an open state;

FIG. 2 is a perspective view showing the first preferred embodiment of this invention in a closed state;

FIG. 3 is a cross-sectional view of FIG. 2;

FIG. 4 is a perspective view showing a second preferred embodiment of this invention in an open state;

FIG. 5 is a perspective view showing the second preferred embodiment of this invention in a closed state;

FIG. 6 is a perspective view showing a third preferred embodiment of this invention;

FIG. 7 is a perspective view showing a fourth preferred embodiment of this invention;

FIG. 8 is a perspective view showing a fifth preferred embodiment of this invention;

FIG. 9 is a schematic view showing the first preferred embodiment of this invention before a taker takes the medicine; and

FIG. 10 is a schematic view showing the first preferred embodiment of this invention when the taker takes the medicine.

### DETAILED DESCRIPTION OF THE PREFERRED EMBODIMENTS

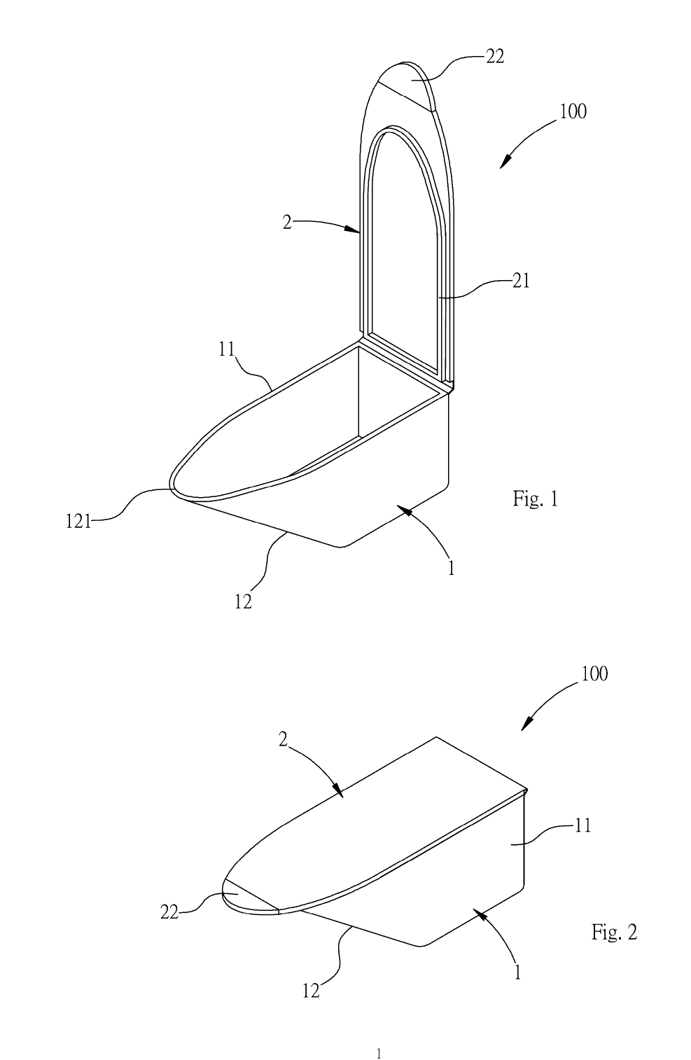

This invention is shown in FIGS. 1-10. A portable medicine feeder 100 of a first preferred embodiment of this invention, as shown in FIGS. 1-3, includes a storage box 1 and a lid 2. The lid 2, preferably, can be made of a soft material.

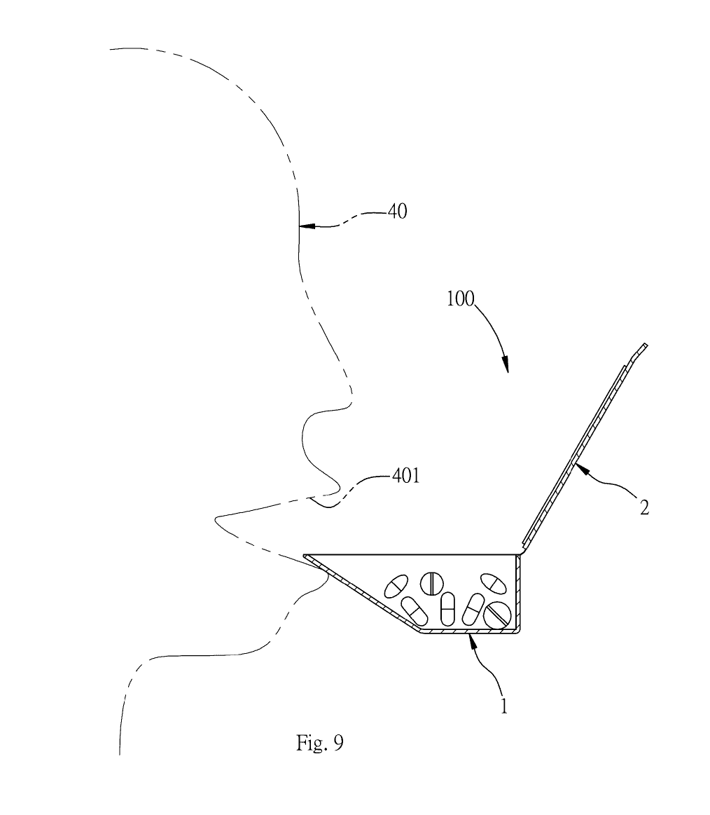

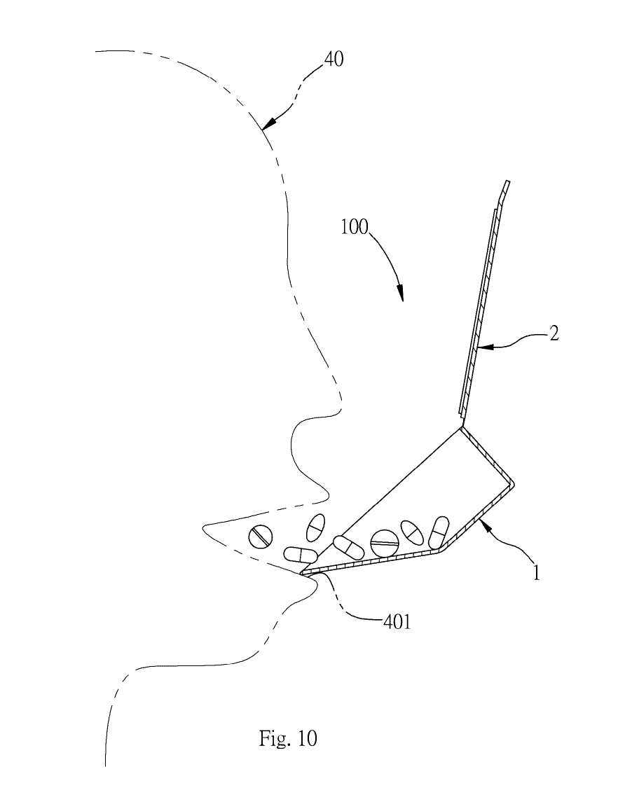

The storage box 1 includes a recessed body 11 and an extension part 12. The extension part 12 extends outward from a front end of the recessed body 11. A bottom of the extension part 12 extends outward and upward from a place close to the recessed body 11, thereby forming a sloping slide outlet 121 with a gradually-reduced rim. A cross-section of the extension part 12 can be in a shape of a pyramid or a cone, and herein the conical shape is adopted as an example. Therefore, a structure having an upward and gradually-reduced slope is formed to allow the slide outlet 121 to be put into and across a labial margin 401 of a taker 40 at the time of feeding. This allows the storage box 1 to slope when a rear of the storage box 1 is raised upward. Thus, medicine pieces, such as pills, can directly slide into the mouth of the taker 40 to complete a feeding operation shown in FIG. 9 and FIG. 10.

A shape of a cross-section of the lid 2 is identical to a shape of a cross-section of a top end of the storage box 1. The lid 2 is disposed over the storage box 1 for opening and closing the top end of the storage box 1. An annular peripheral wall 21 is formed on a lower surface of the lid 2 relative to an inner side edge of the top end of the storage box 1. When the lid 2 covers the storage box 1, the annular peripheral wall 21 abuts against the inner side edge of the top end of the storage box 1.

In this preferred embodiment, a portion of the storage box 1 far away from the extension part 12 and a portion where the lid 2 and the storage box 1 are connected are integrally formed.

Furthermore, a plate 22 extends outward from a part of the lid 2 adjacent to the extension part 12 so that users or patients can push the lid 2 away from the storage box 1.

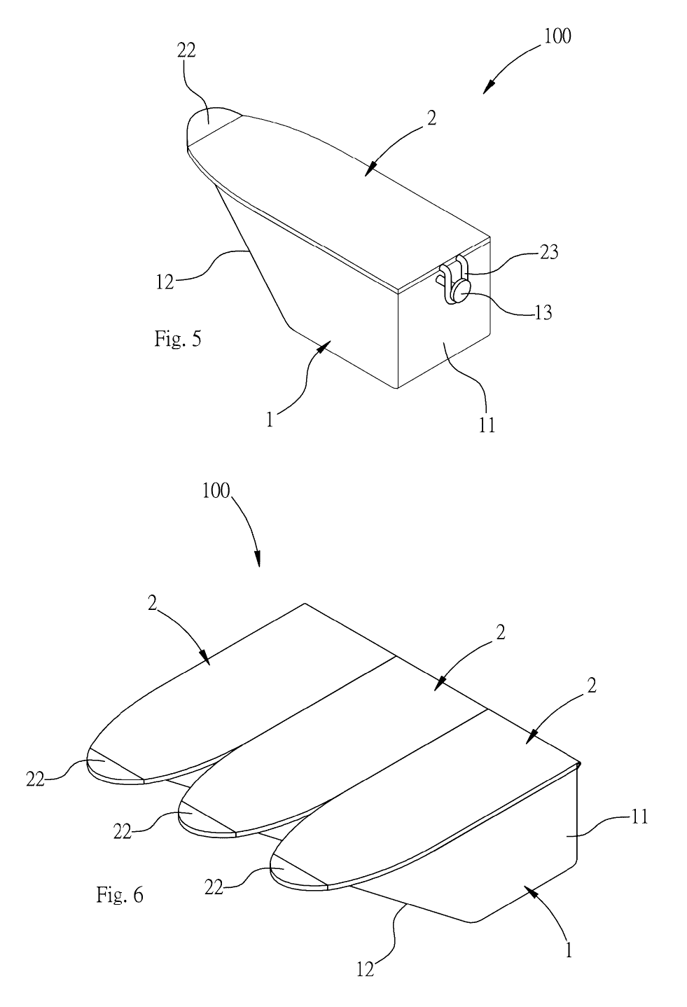

Referring to FIG. 4 and FIG. 5, a second preferred embodiment is shown. This preferred embodiment is characterized in that a pivot shaft 13 extends outward from an upper outside surface of the recessed body 11 far away from the extension part 12. A locking ring 23 is disposed at one end of the lid 2. The locking ring 23 and the pivot shaft 13 of the storage box 1 are pivotally connected to render the lid 2 capable of opening and closing the storage box 1.

FIG. 6 shows a third preferred embodiment. This preferred embodiment is characterized in that a plurality of medicine feeders 100 can be connected together. The medicine feeders 100 are juxtaposed by connecting two side surfaces of the adjacent medicine feeders together and directed toward a same direction.

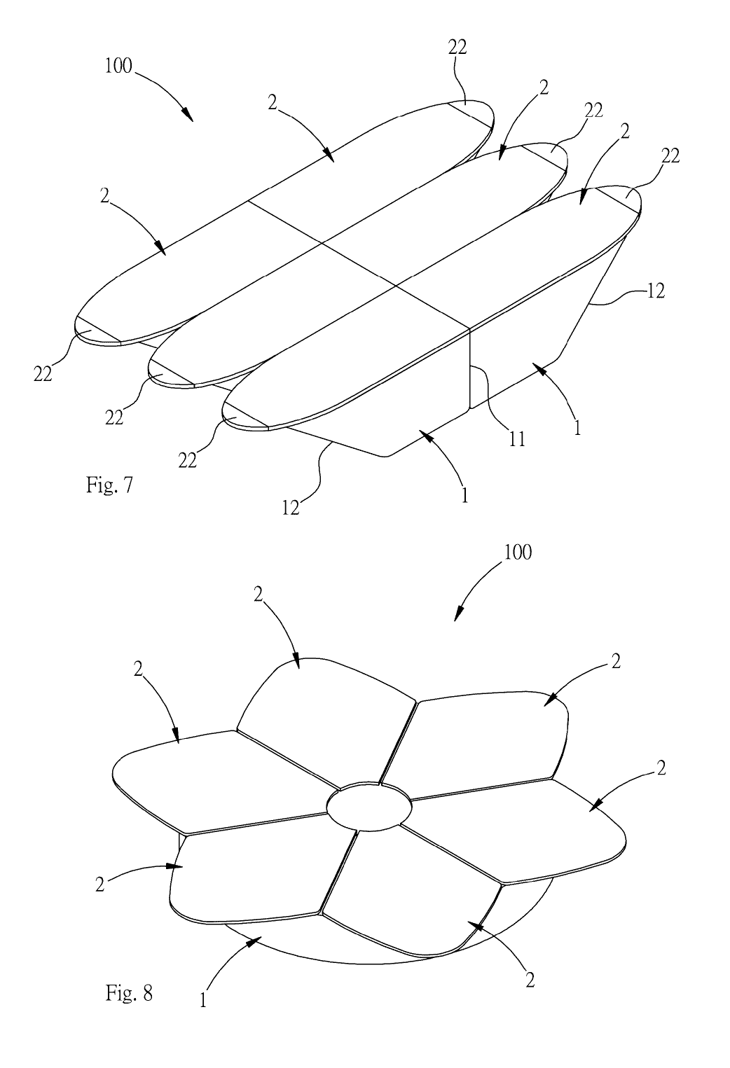

FIG. 7 shows a fourth preferred embodiment based on the structure of the first preferred embodiment. This preferred embodiment is characterized in that a plurality of medicine feeders 100 can be connected together and divided into a first group 200 and a second group 300. The medicine feeders 100 of the first group 200 and the medicine feeders 100 of the second group 300 are respectively juxtaposed by connecting two side surfaces of the adjacent medicine feeders 100 of each group together, and the medicine feeders 100 of each group face a same direction. One end of each medicine feeder 100 of the first group 200 where the storage box 1 and the lid 2 are connected is further connected to one end of each medicine feeder 100 of the second group 300 where the storage box 1 and the lid 2 are connected.

FIG. 8 shows a fifth preferred embodiment based on the structure of the first preferred embodiment. This preferred embodiment is characterized in that a plurality of medicine feeders 100 can be connected together. The medicine feeders 100 can connected side by side and arranged by radiating outward.

With the aid of the aforementioned preferred embodiments, a connection between the lid 2 and the storage box 1 is obtained to fulfill an open-close operation and attain the effect of taking inside medicine pieces, e.g. pills, conveniently. The sloping design of the extension part 12 renders the slide outlet 121 able to go into and across the labial margin of the taker at the time of feeding, so the storage box can slope by raising the rear of the storage box. Therefore, pills or other medicine pieces in the storage box can directly slide into the mouth of the taker to complete the feeding operation . Further, a plurality of portable medicine feeders can be juxtaposed by one line facing a same direction, juxtaposed by two lines facing opposite directions or arranged into a radiating structure which spreads in different directions, thereby providing a variety of choices for consumers and increasing the willingness to consume.

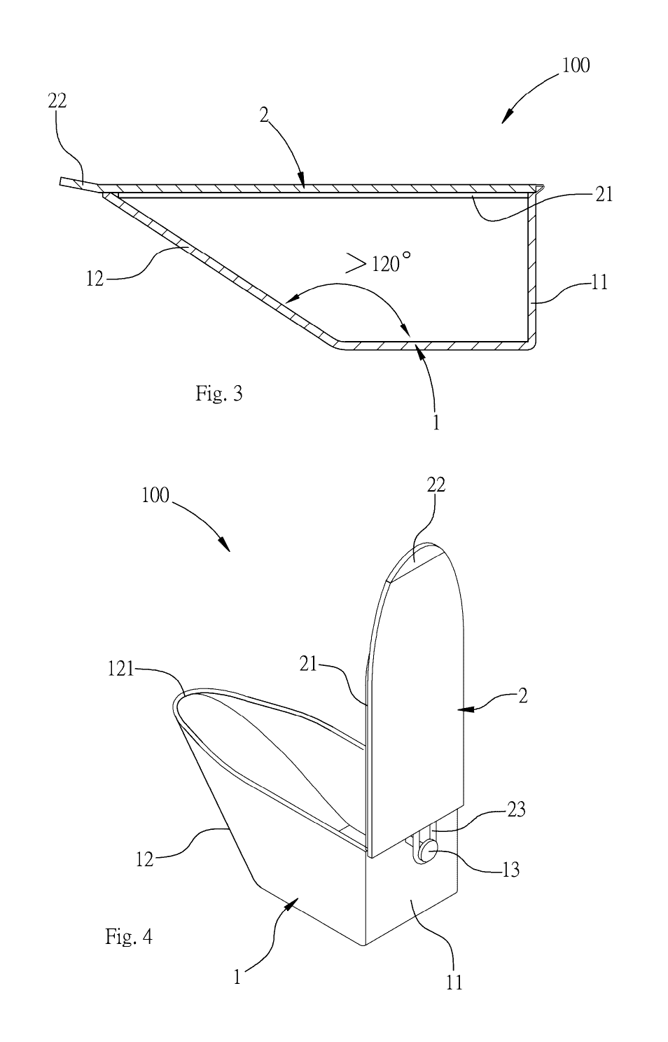

With respect to the portable medicine feeder of this invention, an obtuse angle over 120 degrees is preferably defined between the extension part 12 and a bottom of the storage box 1. Accordingly, when the storage box 1 is set in a sloping state, the inside medicine pieces, e.g. pills, can slide into the mouth of the taker 40 more conveniently and quickly to complete the feeding operation, as shown in FIG. 3.

What is claimed is:

1. A portable medicine feeder comprising a storage box formed by a recessed body and a lid disposed over said storage box for being capable of covering a top end of said storage box, a shape of a cross-section of said lid being identical to a shape of a cross-section of said top end of said storage box, wherein a front end of said storage box has an extension part which extends outward from a front end of said recessed body and reduces gradually to form a gradually-reduced rim, an extension length of said gradually-reduced rime being arranged at least across a labial margin of a taker at a time of feeding to forma sloping slide outlet which defines an obtuse angle over 120 degrees between said gradually-reduced rim of said extension part and a bottom of said storage box.

2. The portable medicine feeder as claimed in claim 1, wherein an annular peripheral wall is formed on a lower surface of said lid relative to an inner side edge of said top end of said storage box, said annular peripheral wall being capable of abutting against said inner side edge of said top end of said storage box when said lid covers said storage box.

3. The portable medicine feeder as claimed in claim 1, wherein a pivot shaft extends outward from an upper outside surface of said recessed body far away from said extension part, a locking ring being disposed at one end of said lid, said locking ring and said pivot shaft of said storage box being pivotally connected to allow said lid to open and close said storage box.

4. The portable medicine feeder as claimed in claim 1, wherein a portion of said storage box far away from said extension part and a portion where said lid and said storage box are connected are integrally formed.

5. The portable medicine feeder as claimed in claim 1, further connecting a plurality of medicine feeders together, said plurality of medicine feeders being juxtaposed by connecting two side surfaces of said medicine feeders together and directed toward a same direction.

6. The portable medicine feeder as claimed in claim 2, further connecting a plurality of medicine feeders together, said plurality of medicine feeders being juxtaposed by connecting two side surfaces of said medicine feeders together and directed toward a same direction.

7. The portable medicine feeder as claimed in claim 3, further connecting a plurality of medicine feeders together, said plurality of medicine feeders being juxtaposed by connecting two side surfaces of said medicine feeders together and directed toward a same direction.

8. The portable medicine feeder as claimed in claim 1, further connecting a plurality of medicine feeders together, said plurality of medicine feeders being divided into a first group and a second group, said medicine feeders of said first group and said medicine feeders of said second group being respectively juxtaposed by connecting two side surfaces of said medicine feeders together, said medicine feeders of each of said first group and said second group facing a same direction, one end of each of said medicine feeders of said first group where said storage box and said lid are connected being connected to one end of each of said medicine feeders of said second group where said storage box and said lid are connected.

9. The portable medicine feeder as claimed in claim 3, further connecting a plurality of medicine feeders together, said plurality of medicine feeders being divided into a first group and a second group, said medicine feeders of said first group and said medicine feeders of said second group being respectively juxtaposed by connecting two side surfaces of said medicine feeders together, said medicine feeders of each of said first group and said second group facing a same direction, one end of each of said medicine feeders of said first group where said storage box and said lid are connected being connected to one end of each of said medicine feeders of said second group where said storage box and said lid are connected.

10. The portable medicine feeder as claimed in claim 1, further connecting a plurality of medicine feeders together, said plurality of medicine feeders being connected side by side and arranged by radiating outward.

11. The portable medicine feeder as claimed in claim 3, further connecting a plurality of medicine feeders together, said plurality of medicine feeders being connected side by side and arranged by radiating outward.

12. The portable medicine feeder as claimed in claim 1, wherein a plate extends outward from a part of said lid adjacent to said extension part.

13. The portable medicine feeder as claimed in claim 2, wherein a plate extends outward from a part of said lid adjacent to said extension part.

14. The portable medicine feeder as claimed in claim 3, wherein a plate extends outward from a part of said lid adjacent to said extension part.

15. The portable medicine feeder as claimed in claim 1, wherein said lid is made of a soft material.

16. The portable medicine feeder as claimed claim 2, wherein said lid is made of a soft material.

17. The portable medicine feeder as claimed in claim 3, wherein said lid is made of a soft material.
